(19) United States
(12) Patent Application Publication
(10) Pub. No.: US 2025/0306618 A1
(43) Pub. Date: Oct. 2, 2025

(54) VOLTAGE REGULATOR AND SEMICONDUCTOR DEVICE

(71) Applicant: ABLIC Inc., Nagano (JP)

(72) Inventors: Takuya Obayashi, Nagano (JP); Yasuhiko OGURA, Nagano (JP); Kaoru SAKAGUCHI, Nagano (JP)

(73) Assignee: ABLIC Inc., Nagano (JP)

(21) Appl. No.: 19/021,174

(22) Filed: Jan. 15, 2025

(30) Foreign Application Priority Data
Mar. 28, 2024 (JP) 2024-052836
Sep. 30, 2024 (JP) 2024-170768

(51) Int. Cl. G05F 1/575

(52) U.S. Cl. CPC G05F 1/575

(57) ABSTRACT

A voltage regulator capable of avoiding gain peaking includes: a differential amplifier circuit which amplifies and outputs a difference between a reference voltage and a divided voltage obtained by dividing a voltage output by an output transistor, and controls a gate of the output transistor; and a phase compensation circuit. The phase compensation circuit includes: a first transistor which contains a drain connected to an output port of the differential amplifier circuit; a second transistor which contains a drain connected to a gate of the first transistor and a gate connected to the gate of the first transistor via at least a first resistance, and is connected to a drain of the output transistor via a first capacity; and a second capacity connected in parallel with the first resistance.

### CROSS-REFERENCE TO RELATED APPLICATION

This application claims the priority benefits of Japanese application no. 2024-052836, filed on Mar. 28, 2024, and Japanese application no. 2024-170768, filed on Sep. 30, 2024. The entirety of each of the above-mentioned patent applications is hereby incorporated by reference herein and made a part of this specification.

### BACKGROUND

### Technical Field

The present invention relates to a voltage regulator and a semiconductor device.

### Description of Related Art

Conventionally, a voltage regulator capable of outputting a constant voltage lower than an input voltage is widely used as an integrated circuit (IC) for power supply in an electronic device. Such a voltage regulator includes a phase compensation function which can suppress oscillation. For example, Non-Patent Document 1 (IEEE TRANSACTIONS ON CIRCUITS AND SYSTEMS: REGULAR PAPERS, VOL. 54, NO. 9 Sep. 2007) is known as a document which discloses a voltage regulator including a phase compensation function.

The conventional circuit described in Non-Patent Document 1 includes a boost circuit for improved transient characteristics. In some cases, under heavy load, the pole at an output port and the pole at a gate port of an output transistor approach each other, resulting in deterioration of the phase margin.

First, referring to FIG. 7 to FIGS. 9A and 9B, the issues related to conventional technology are described.

FIG. 7 is a circuit diagram illustrating a voltage regulator related to conventional technology. First, referring to the figure, a voltage regulator 90 related to conventional technology is described. The voltage regulator 90 generates a constant output voltage vout lower than the input voltage based on an input voltage vin applied between a ground port and a power supply port, and outputs the output voltage vout to an output port. A predetermined load resistance and load capacity (not illustrated) are connected to the output port.

Specifically, the voltage regulator 90 includes an output transistor MP1, a differential amplifier circuit 92, a phase compensation circuit 99, a resistance R1 (an element containing a resistance value r1), and a resistance R2 (an element containing a resistance value r₂). The phase compensation circuit 99 includes an N-channel type transistor MN2, an N-channel type transistor MN1, a resistance R3 (an element containing a resistance value r₃), and a capacity C1 (an element containing a capacitance value c₁).

The differential amplifier circuit 92 includes an inverting input port, a non-inverting input port, and an output port. Additionally, the differential amplifier circuit 92 includes a positive power supply port and a negative power supply port (not illustrated). The inverting input port is connected to a reference voltage circuit, and a predetermined reference voltage vref is applied. The non-inverting input port is connected to a connection point of the resistance R1 and the resistance R2. The output port is connected to a gate port of the output transistor MP1. The differential amplifier circuit 92 amplifies and outputs the difference between a divided voltage (i.e., the voltage at the connection point of the resistance R1 and the resistance R2) obtained by dividing the voltage output by the output transistor MP1 and the reference voltage vref, and controls a gate of the output transistor MP1.

The transistor MN2 contains a drain connected to the output port of the differential amplifier circuit 92, a source connected to the ground port, and a gate connected to one end of the resistance R3 and a drain of the transistor MN1. The transistor MN1 contains the drain connected to the gate of the transistor MN2, a source connected to the ground port, and a gate connected to the other end of the resistance R3 and one end of the capacity C1. The other end of the capacity C1 is connected to the output port and a drain of the output transistor MP1.

A predetermined current control circuit is connected to the drain of the transistor MN2 and the drain of the transistor MN1.

FIG. 8 is a circuit diagram illustrating a small signal equivalent circuit of a voltage regulator related to conventional technology. The figure illustrates the small signal equivalent circuit of the voltage regulator 90 illustrated in FIG. 7. A capacity Cd1 (an element containing a capacitance value c_{d1}) represents the drain-source capacity of the transistor MN1, and a resistance Rd1 (an element containing a resistance value r_{d1}) represents the drain-source resistance of the transistor MN1. Additionally, transconductance gm1 and transconductance gm2 represent the transconductance of the transistor MN1 and the transconductance of the transistor MN2, respectively.

Here, the relationship between a voltage vg at a node N92 connected to the gate of the transistor MN2 and the output voltage vout at the drain of the output transistor MP1 (in other words, the transfer function in the case of the output port being the input and the node N92 being the output) can be expressed by the following Formula (1).

$$\begin{matrix}[ Formula 1 ] & \\ \frac{{v}_{g}}{{v}_{out}} = - j ω {r}_{d 1} {c}_{1} \frac{{g}_{m 1} {r}_{3} - 1}{1 + {g}_{m 1} {r}_{d 1}} \frac{1}{1 - {ω}^{2} \frac{{c}_{1} {c}_{d 1} {r}_{3} {r}_{d 1}}{1 + {g}_{m 1} {r}_{d 1}} + j ω \frac{{c}_{d 1} {r}_{d 1} + {c}_{1} ( {r}_{d 1} + {r}_{3} )}{1 + {g}_{m 1} {r}_{d 1}}} & ( 1 )\end{matrix}$$

FIGS. 9A and 9B are graphs illustrating the frequency characteristic of gain in a voltage regulator related to conventional technology. The lateral axis of the figure indicates the frequency [Hz], and the longitudinal axis indicates the gain [dB]. Frequency fp1 of a first pole illustrated in the figure is the frequency of the first pole generated by the load capacity connected to the output port. Frequency fp2 of a second pole and frequency fp3 of a third pole are the frequency of the second pole and the frequency of the third pole at the node N92, respectively.

FIG. 9A illustrates the frequency characteristic of gain under normal load. The frequency fp1 of the first pole and the pole generated at a node N91 are sufficiently separated. Therefore, under normal load, phase compensation is sufficiently probable. Here, the frequency fp2 of the second pole and the frequency fp3 of the third pole are determined by the ω² term, the ω term, and the integer term existing in the denominator of Formula (1). Under heavy load, the frequency fp1 of the first pole moves to the high frequency domain and approaches the pole generated at the node N91. In other words, under heavy load, there have been cases where phase compensation becomes difficult.

FIG. 9B illustrates the frequency characteristic of gain as an improvement measure under heavy load, where the capacity C1 is increased and the transconductance gm1 of the transistor MN1 is further increased. In this case, the phase compensation at the node N92 can be made effective from the low frequency domain, thereby improving the phase. On the other hand, in this case, there have been instances where the attenuation coefficient becomes smaller, potentially causing gain peaking to occur.

The present invention provides a voltage regulator and a semiconductor device capable of avoiding gain peaking.

### SUMMARY

A voltage regulator according to an embodiment of the present invention includes: a differential amplifier circuit which amplifies and outputs a difference between a reference voltage and a divided voltage obtained by dividing a voltage output by an output transistor, and controls a gate of the output transistor; and a phase compensation circuit. The phase compensation circuit includes: a first transistor which contains a drain connected to an output port of the differential amplifier circuit; a second transistor which contains a drain connected to a gate of the first transistor and a gate connected to the gate of the first transistor via at least a first resistance, and is connected to a drain of the output transistor via a first capacity; and a second capacity connected in parallel with the first resistance.

According to the present invention, a voltage regulator and a semiconductor device capable of avoiding gain peaking can be provided.

### BRIEF DESCRIPTION OF THE DRAWINGS

FIG. 1 is a circuit diagram illustrating a voltage regulator according to a first embodiment.

FIG. 2 is a circuit diagram illustrating a small signal equivalent circuit of the voltage regulator according to the first embodiment.

FIG. 3 is a graph illustrating the frequency characteristic of gain in the voltage regulator according to the first embodiment.

FIG. 4 is a circuit diagram illustrating a voltage regulator according to a second embodiment.

FIG. 5 is a circuit diagram illustrating a small signal equivalent circuit of the voltage regulator according to the second embodiment.

FIG. 6 is a graph illustrating the frequency characteristic of gain in the voltage regulator according to the second embodiment.

FIG. 7 is a circuit diagram illustrating a voltage regulator related to conventional technology.

FIG. 8 is a circuit diagram illustrating a small signal equivalent circuit of the voltage regulator related to conventional technology.

FIGS. 9A and 9B are graphs illustrating the frequency characteristic of gain in the voltage regulator related to conventional technology.

### DESCRIPTION OF THE EMBODIMENTS

### Embodiment

The following describes in detail a voltage regulator related to an embodiment of the present invention, with reference to the attached drawings, by presenting exemplary embodiments.

### First Embodiment

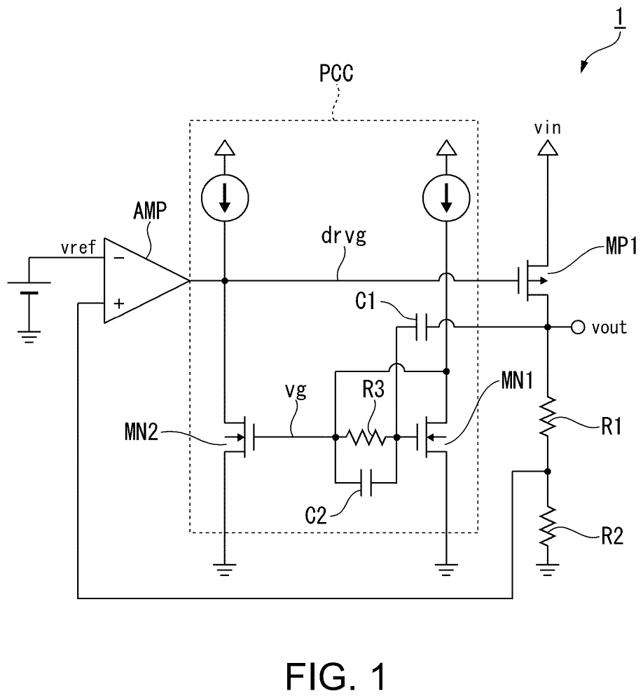

FIG. 1 is a circuit diagram illustrating a voltage regulator according to a first embodiment. First, the circuit configuration of a voltage regulator 1 according to the first embodiment is described with reference to the figure. The voltage regulator 1 generates a constant output voltage vout lower than the input voltage based on an input voltage vin applied between a ground port and a power supply port, and outputs the output voltage vout to an output port. A predetermined load resistance and load capacity (not illustrated) are connected to the output port.

Specifically, the voltage regulator 1 includes an output transistor MP1, a differential amplifier circuit AMP, a phase compensation circuit PCC, a resistance R1, and a resistance R2. The phase compensation circuit PCC includes an N-channel type transistor MN1, an N-channel type transistor MN2, a resistance R3, a capacity C1, and a capacity C2 (an element containing a capacitance value c₂). In other words, the voltage regulator 1 differs from the voltage regulator 90 related to conventional technology described above in that the voltage regulator 1 further includes the capacity C2 connected in parallel with the resistance R3.

In the following description, the transistor MN1 may be referred to as a first transistor, the transistor MN2 as a second transistor, the capacity C1 as a first capacity, the capacity C2 as a second capacity, and the resistance R3 as a first resistance.

The differential amplifier circuit AMP includes an inverting input port, a non-inverting input port, and an output port. Additionally, the differential amplifier circuit AMP includes a positive power supply port and a negative power supply port (not illustrated). The inverting input port is connected to a reference voltage circuit, and a predetermined reference voltage vref is applied. The non-inverting input port is connected to a connection point of the resistance R1 and the resistance R2. The output port is connected to a gate port of the output transistor MP1. The differential amplifier circuit AMP amplifies and outputs the difference between a divided voltage (i.e., the voltage at the connection point of the resistance R1 and the resistance R2) obtained by dividing the voltage output by the output transistor MP1 and the reference voltage vref, and controls a gate of the output transistor MP1.

The transistor MN2 contains a drain connected to the output port of the differential amplifier circuit AMP, a source connected to the ground port, and a gate connected to one end of the resistance R3, one end of the capacity C2, and a drain of the transistor MN1. The transistor MN1 contains the drain connected to the gate of the transistor MN2, a source connected to the ground port, and a gate connected to the other end of the resistance R3, the other end of the capacity C2, and one end of the capacity C1. The other end of the capacity C1 is connected to the output port and a drain of the output transistor MP1.

A predetermined current control circuit is connected to the drain of the transistor MN1 and the drain of the transistor MN2.

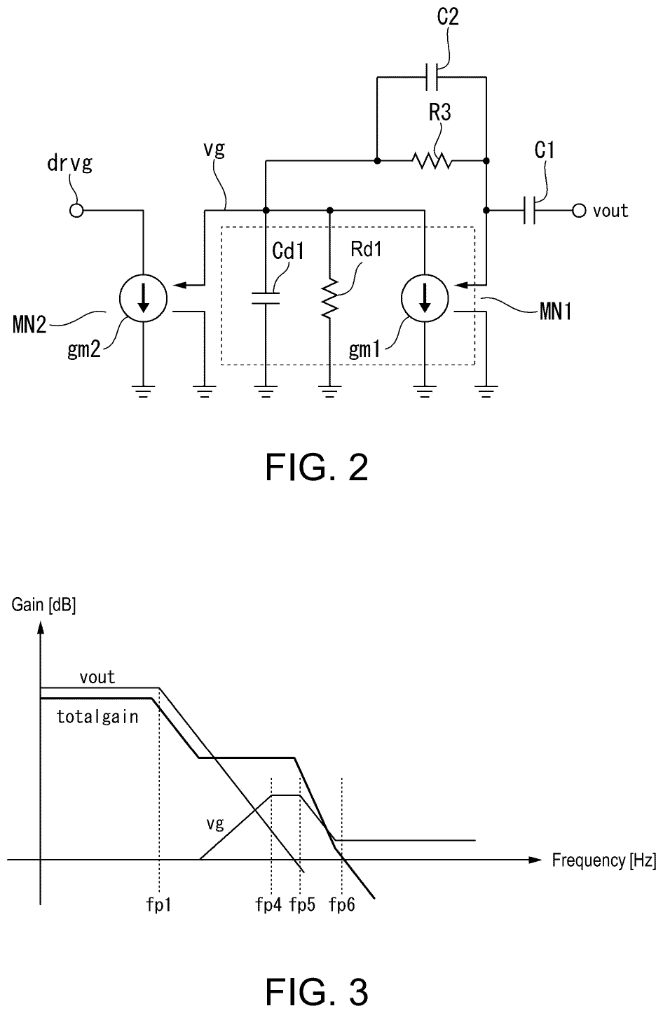

FIG. 2 is a circuit diagram illustrating a small signal equivalent circuit of the voltage regulator according to the first embodiment. A capacity Cd1 represents the drain-source capacity of the transistor MN1, and a resistance rd1 represents the drain-source resistance of the transistor MN1. Additionally, transconductance gm1 and transconductance gm2 represent the transconductance of the transistor MN1 and the transconductance of the transistor MN2, respectively.

Here, the relationship between a voltage vg at the gate of the transistor MN2 and the output voltage vout at the drain of the output transistor MP1 (in other words, the transfer function in the case of the output port being the input and the gate of the transistor MN2 being the output) can be expressed by the following Formula (2).

$$\begin{matrix}[ Formula 2 ] & \\ \frac{{v}_{g}}{{v}_{out}} = - j ω {r}_{d 1} {c}_{1} \frac{{g}_{m 1} {r}_{1} - 1}{1 + {g}_{m 1} {r}_{d 1}} \frac{1 + j ω \frac{{c}_{2} {r}_{3}}{1 - {g}_{m 1} {r}_{3}}}{1 - {ω}^{2} \frac{{c}_{1} {c}_{2} {r}_{3} {r}_{d 1}}{1 + {g}_{m 1} {r}_{d 1}} + j ω ( {c}_{2} {r}_{3} \frac{{c}_{1} ( {r}_{d 1} + {r}_{3} )}{1 + {g}_{m 1} {r}_{d 1}} )} & ( 2 )\end{matrix}$$

In Formula (2), it is approximated that c_{d1}<<c₁, and c_{d1}<<c₂.

FIG. 3 is a graph illustrating the frequency characteristic of gain in the voltage regulator according to the first embodiment. The lateral axis of the figure indicates the frequency [Hz], and the longitudinal axis indicates the gain [dB]. Frequency fp1 of a first pole illustrated in the figure is the frequency of the first pole generated by the output capacity connected to the output port. Frequency fp4 of a fourth pole and frequency fp5 of a fifth pole are determined by the ω² term, the ω term, and the integer term existing in the denominator of Formula (2). Frequency fp6 of a sixth pole is the zero point determined from the ω term and the integer term existing in the numerator of Formula (2).

According to the embodiment, by adding the capacity C2 in parallel with the resistance R3, the attenuation coefficient of the transfer function illustrated in Formula (2) is increased. By increasing the attenuation coefficient, gain peaking can be suppressed. The capacity ratio of the capacity C1 to the capacity C2 is preferably in the range of 1:1 to 4:1.

### Second Embodiment

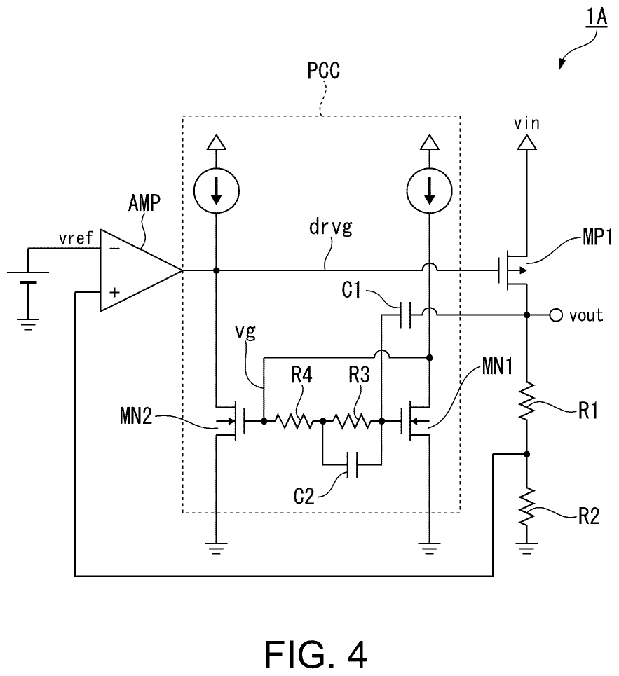

FIG. 4 is a circuit diagram illustrating a voltage regulator according to a second embodiment. First, the circuit configuration of a voltage regulator 1A according to the second embodiment is described with reference to the figure. In the description of the voltage regulator 1A, descriptions may be omitted for configurations similar to the configurations of the voltage regulator 1 by assigning the same reference numerals. The voltage regulator 1A differs from the voltage regulator 1 in that the voltage regulator 1A further includes a resistance R4 (an element containing a resistance value r₄). In the following description, the resistance R4 may be referred to as a second resistance.

The resistance R4 is connected between the gate of transistor MN2 and the resistance R3. In other words, one end of the resistance R4 is connected to the gate of transistor MN2 and the drain of transistor MN1, and the other end is connected to the gate of transistor MN1 via the resistance R3. In the voltage regulator 1A, similar to the voltage regulator 1, the capacity C2 is connected in parallel with the resistance R3.

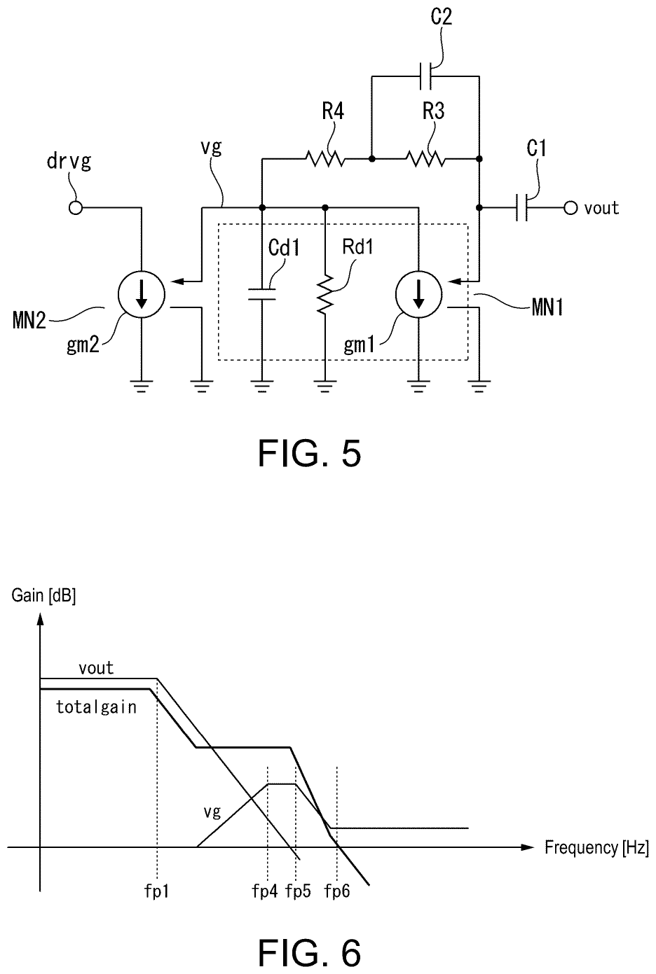

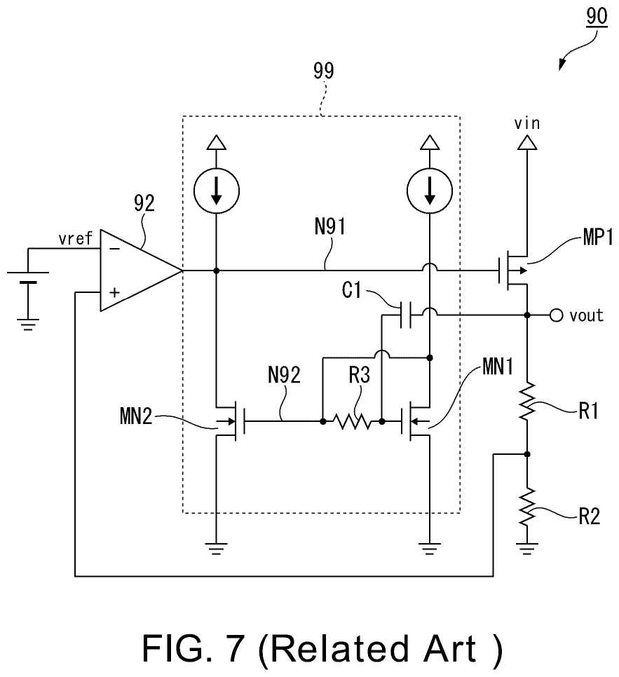

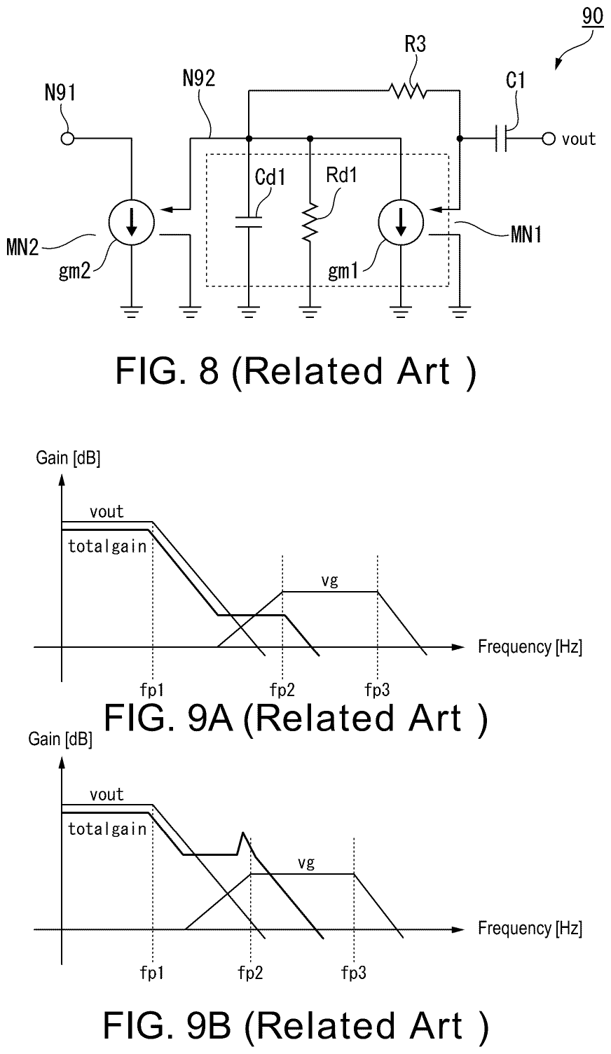

FIG. 5 is a circuit diagram illustrating a small signal equivalent circuit of the voltage regulator according to the second embodiment. The figure illustrates the small signal equivalent circuit of the voltage regulator 1A illustrated in FIG. 4. A capacity Cd1 represents the drain-source capacity of the transistor MN1, and a resistance rd1 represents the drain-source resistance of the transistor MN1. Additionally, transconductance gm1 and transconductance gm2 represent the transconductance of the transistor MN1 and the transconductance of the transistor MN2, respectively.

Here, the relationship between the voltage vg at the gate of transistor MN2 and the output voltage vout at the drain of the output transistor MP1 (in other words, the transfer function in the case of the output port being the input and the gate of the transistor MN2 being the output) can be expressed by the following Formula (3).

$$\begin{matrix}[ Formula 3 ] & \\ \frac{{v}_{g}}{{v}_{out}} = - j ω {r}_{d 1} {c}_{1} \frac{{g}_{m 1} ( {r}_{3} + {r}_{4} ) - 1}{1 + {g}_{m 1} {r}_{d 1}} \frac{1 + j ω \frac{{c}_{2} {r}_{3} ( 1 - {g}_{m 1} {r}_{4} )}{1 - {g}_{m 1} ( {r}_{3} + {r}_{4} )}}{\begin{matrix}1 - {ω}^{2} \frac{{c}_{1} {c}_{2} {r}_{3} ( {r}_{d 1} + {r}_{4} )}{1 + {g}_{m 1} {r}_{d 1}} + \\ j ω ( {c}_{2} {r}_{3} + \frac{{c}_{2} ( {r}_{d 1} + {r}_{3} + {r}_{4} ) - {ω}^{2} {c}_{1} {c}_{2} {c}_{d 1} {r}_{d 1} {r}_{3} {r}_{4}}{1 + {g}_{m 1} {r}_{d 1}} )\end{matrix}} & ( 3 )\end{matrix}$$

FIG. 6 is a graph illustrating the frequency characteristic of gain in the voltage regulator according to the second embodiment. The lateral axis of the figure indicates the frequency [Hz], and the longitudinal axis indicates the gain [dB]. Similar to FIG. 3, the frequency fp1 of the first pole illustrated in the figure is the frequency of the first pole generated by the output capacity connected to the output port. The frequency fp4 of the fourth pole and the frequency fp5 of the fifth pole are determined by the ω² term, the ω term, and the integer term existing in the denominator of Formula (2). The frequency fp6 of the sixth pole is determined by the ω term and the integer term existing in the numerator of Formula (2).

Here, in Formula (3), if gₘ₁r₄>1 is satisfied, in response to being expressed as A+jbω (where A is the real part and bω is the imaginary part), the imaginary part of the zero point becomes positive, and the phase can be improved. The resistance ratio of the resistance R3 to the resistance R4 is preferably about 1:1 to 4:1.

According to the embodiment, gain peaking can be avoided, and phase margin can be secured by making the imaginary part of the zero point positive. As a result, a voltage regulator with excellent alternating current (AC) characteristics can be realized even with a small output capacity.

The voltage regulator 1 or 1A according to the embodiment may be realized as a predetermined semiconductor device. The semiconductor device may include at least the voltage regulator 1 or 1A. The semiconductor device may include, in addition to the voltage regulator 1 or 1A, a predetermined control circuit and peripheral circuits etc.

The present invention has been described using embodiments to describe the aspects for carrying out the present invention, but the specific aspects related to the present invention are not limited to the embodiments in any way, and various modifications, substitutions, and design changes etc. can be added within the scope which does not deviate from the spirit of the present invention. For example, similar effects can be obtained by interchanging all NMOS transistors and PMOS transistors and configuring the circuit in an inverted manner.

Moreover, the above-mentioned embodiments and the configurations described in the respective embodiments may be combined and implemented.

What is claimed is:

1. A voltage regulator, comprising:
a differential amplifier circuit, amplifying and outputting a difference between a reference voltage and a divided voltage obtained by dividing a voltage output by an output transistor, and controlling a gate of the output transistor; and
a phase compensation circuit, and
the phase compensation circuit comprising
a first transistor which contains a drain connected to an output port of the differential amplifier circuit,
a second transistor which contains a drain connected to a gate of the first transistor, and a gate connected to the gate of the first transistor via at least a first resistance, and is connected to a drain of the output transistor via a first capacity, and
a second capacity connected in parallel with the first resistance.

2. The voltage regulator according to claim 1, wherein
a capacity ratio of the first capacity to the second capacity is between 1:1 and 4:1.

3. The voltage regulator according to claim 1, further comprising:
a second resistance, containing one end connected to the gate of the first transistor and the other end connected to a gate of the second transistor via the first resistance.

4. The voltage regulator according to claim 3, wherein
a resistance ratio of the first resistance to the second resistance is between 1:1 and 4:1.

5. A semiconductor device, comprising the voltage regulator according to claim 1.
